(19) United States
(12) Patent Application Publication
(10) Pub. No.: US 2009/0001176 A1
(43) Pub. Date: Jan. 1, 2009

(54) Method And Device For Forming A Chip-Containing Label

(76) Inventors: Christophe Peynet, L'Hay les Roses (FR); Etienne Roger, Maisons Laffite (FR); Jean-Louis Natta, Reuil Malmaison (FR)

Correspondence Address: GREER, BURNS & CRAIN, 300 S WACKER DR, 25TH FLOOR, CHICAGO, IL, 60606, US

(21) Appl. No.: 11/597,738

(22) PCT Filed: May 28, 2004
(86) PCT No.: PCT/FR2004/001324

§ 371 Date: Apr. 14, 2008

(51) Int. Cl. G06K 19/067

(52) U.S. Cl. 235/492

(57) ABSTRACT

A method for forming a label and a label formed thereby comprising a chip affixed to a sheet, the chip being provided on a support, where the label is formed by applying the support to a surface of the sheet and by printing first information which individualizes the label, characterized in that the support and the surface thus form a part of the label where the first printed information is readable.

The present invention relates to a method and a device for forming a label provided with a chip, in particular a luggage label, the label then comprising information relating to the luggage, in particular its destination. The present invention also relates to a label thus formed.

Currently, luggage labels are typically formed using a pre-pasted strip, that is printed on request with information making it possible to individualize the label and therefore the luggage bearing it, which strip is cut up into tags. Then, the tag is stuck together around a handle of the luggage or flat on a package. For this purpose, the strip comprises a sheet comprising a printable surface and a pre-pasted surface supporting an adhesive, the adhesive itself, and a protection made of removable backing paper covering and protecting the adhesive.

As for the information recorded at check-in it must be able to be read by the luggage identification and routing system. This problem is generally solved by printing onto the label both written information and a barcode, this barcode allowing automatic processing of the luggage by the luggage identification and routing system. However, the label generally formed by a paper tag is fragile and the zone bearing the barcode can be damaged during frequent handling of the luggage. Moreover, since it is a visual reading, the barcode must be visible to the automatic reader, which may not be the case if the label is facing in the wrong direction or optionally hidden by the luggage. Such reading difficulties can require a human reading of the written information, which slows down the processing of a batch of luggage, and/or causes errors in routing.

One solution is to attach a radiofrequency chip to the tag. However, the labels are formed using consumables provided by each airline. These consumables generally correspond to a chart and often have a format specific to each company, comprising its logo or its name.

This problem can be solved by attaching the chip at the check-in desk, for example, at the time when the passenger checks in.

However, it is not possible to attach the chip to the back (i.e. opposite the printable surface) of the label. In fact, until the label is placed on the luggage, the back of the label is constituted by the backing paper and the chip cannot be stuck to it.

This problem is solved by the document FR 2 760 209, which describes a chip affixed to the face of the label. However, it is necessary to use a specific layout of the printed information, writing and barcode, in order to allow room for the chip and its support.

A purpose of the invention is to propose a method for forming a label comprising a chip and making it possible to use, without its modification, the printing layout as provided for a label without a chip.

According to a first subject of the invention, a method for forming such a label comprising a chip affixed to a sheet, the chip being provided on a support, where the label is formed by applying said support to a surface of the sheet and by printing first information which individualizes the label, is characterized in that said support and said surface thus form a part of the label where the first printed information can be read. The chip can be a radiofrequency chip in order to contain second information which individualizes the label.

Advantageously, according to a first embodiment, the first information is printed on the surface, before applying thereto a transparent or translucent support which covers, at least partially, said first information. Still more advantageously, the support is applied in such a way that the chip, and also more advantageously its antenna if it is a radiofrequency chip, is offset beyond one edge of the sheet.

Advantageously, according to a second embodiment, the first information is printed after having applied a printable support on the surface.

The invention also includes a device for implementing a support according to the invention.

The invention also includes a label comprising a chip affixed to a sheet, the chip being provided on a support applied to a surface of the sheet, said label comprising a first written information individualizing the label, and characterized in that said support and said surface form a part of the label where the first information is readable.

Advantageously, the support is translucent or transparent. More advantageously, the chip, and also more advantageously its antenna if this is a radiofrequency chip, is offset relative to one edge of the sheet. Instead of an offset antenna, the label can comprise a transparent or translucent antenna. The chip and its antenna can then be arranged between the support and the surface. The support being translucent or transparent, it can cover at least partially the first information.

In particular, if the support is not transparent or translucent, it can advantageously be printable. Then, the first information can be printed, at least partially, on the support.

Generally, the chip is intended to receive second information, repeating at least one part of the information printed on the label, and making it possible to individualize the label, for example, in the case of a luggage label, to identify the passenger, the luggage and its destination.

For the requirements of the description of the invention, first and second information are understood to mean information different to that which can be printed in an undifferentiated manner, for example the logo and the name of an airline, which can be printed on the consumable serving to form the support of the label, or also the name of the check-in terminal, which can be recorded on the chip.

Other characteristics and advantages of the invention will also become apparent from the description below, which relates to non-limitative examples.

In the attached drawings:

FIG. 1 is a plan view of a first embodiment for a label according to the invention;

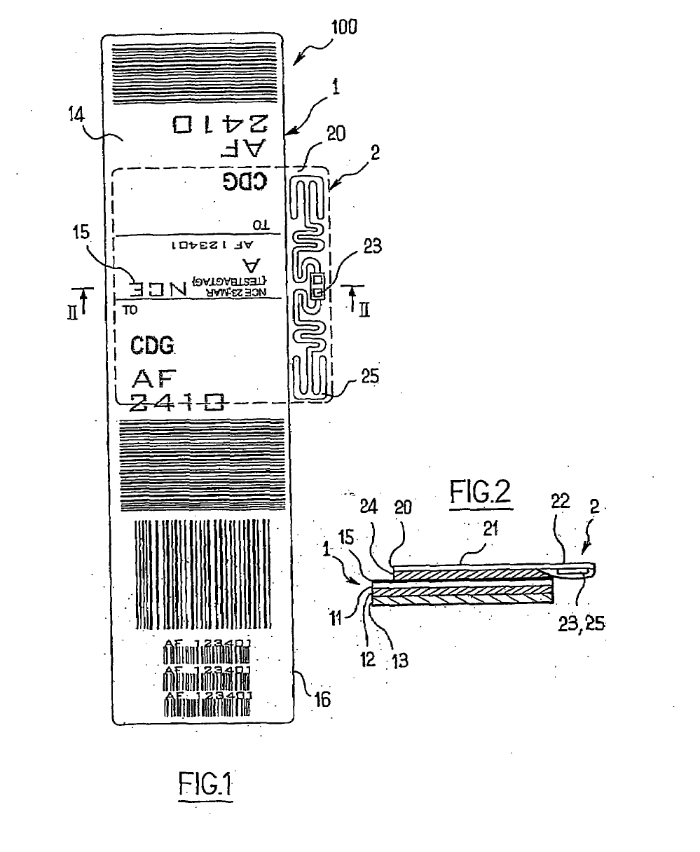

FIG. 2 is a cross-section along II-II, of the label of FIG. 1;

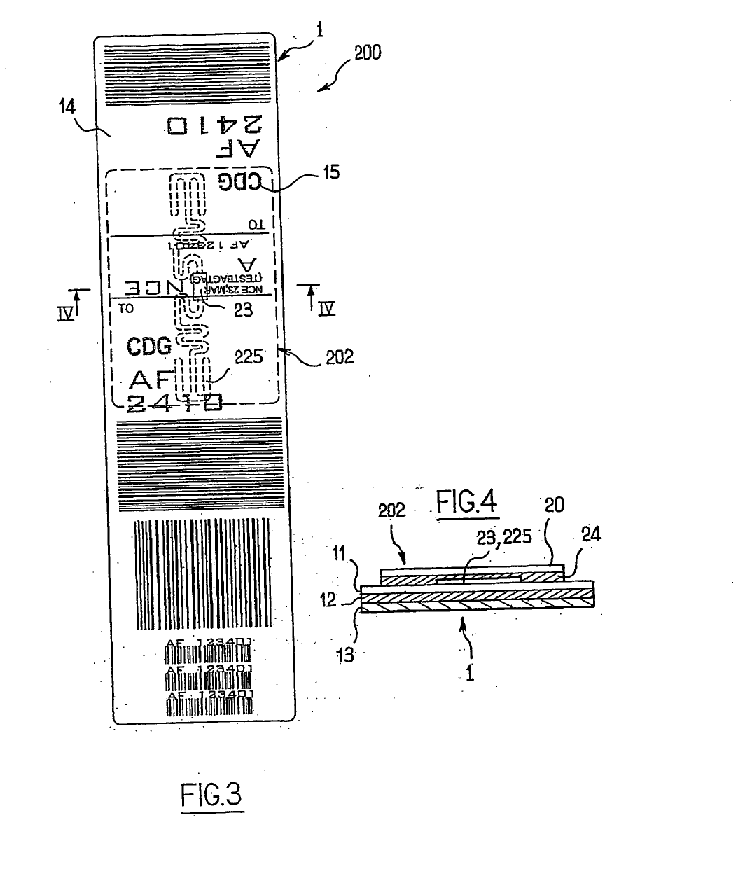

FIG. 3 is a plan view of a second embodiment for a label according to the invention;

FIG. 4 is a cross-section along IV-IV, of the label of FIG. 3;

FIG. 5 is a plan view of a third embodiment for a label according to the invention; and,

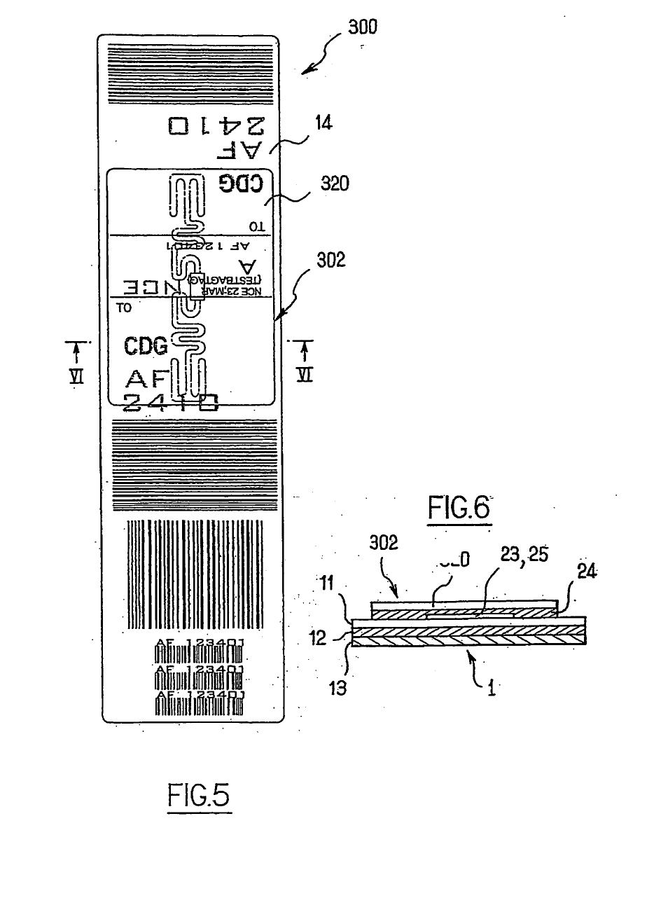

FIG. 6 is a cross-section along VI-VI, of the label of FIG. 5;

FIG. 1 illustrates the back of a luggage label 100 according to the invention in a first embodiment. As illustrated more specifically in FIG. 2, this label comprises several layers. For reasons of legibility, the thicknesses of the different layers have been greatly increased. The label principally comprises a tag 1 and a chip assembly 2.

The tag 1 comprises a printable sheet 11, for example made of thermal paper, a layer of adhesive 12 situated on the under-side of the sheet 11, and a removable protection 13, for example a backing paper, covering the adhesive.

A printable surface 14 of the sheet, represented in this case as printed, of the sheet opposite the surface carrying the layer of adhesive 12, supports printed information 15, individualizing the label, for the purposes of identifying an item of luggage. This information comprises alphanumeric characters and barcodes.

The chip assembly 2 comprises a transparent support 20 for an antenna-radiofrequency chip assembly 23. This support is transparent, which is illustrated by its representation in dotted lines. A first part 21 of the support 20 has on its under-side a layer of adhesive 24 which is itself transparent, applied to the printed surface of the sheet 11, in order to attach the chip assembly 2 to the tag 1. A second part 22 of the support 20 has, on its under-side, the chip 23 and an antenna 25 of the chip.

The chip assembly 2 is arranged on the tag 1 in such a way that the second part 22 does not cover the printed surface 14.

Thus, the information 15 is covered by the first part 21 of the support, and is still readable through the support 20 because it is transparent. The chip 23 and its antenna 25, are offset laterally relative to one edge 16 of the sheet 11. Thus, neither the antenna, nor the chip, which are both opaque, cover or mask a part of the sheet and therefore the information, without the addition of the chip 23 to the label requiring modification of the layout of the printed information 15.

FIGS. 3 and 4 illustrate a second embodiment for a label 200 according to the invention. This label will now be described with regard to how it differs from the label 100 described previously. The reference numbers will be retained in as far as they designate similar elements.

The antennae of the chips are generally produced by electrodeposition or by screen printing. The use of an ink which is translucent to visible or infrared light or also to ultraviolet light, can make it possible to produce a translucent antenna.

The chip assembly 202 comprises a chip 23 equipped with such a translucent antenna 225, which is illustrated by dotted lines. Only the chip remains opaque. However, the size of the current chips is relatively small, such that they are not able to mask a significant part of the information. Moreover, and taking into account the layout provided for the printed information, the chip can be arranged in such a way as to cover, for example, a zone which is never printed.

In the embodiments of FIGS. 1 to 4, the printing is carried out before the placement of the chip assembly, without the need to modify the layout of the printed information.

FIGS. 5 and 6 illustrate a third embodiment for a label 300 according to the invention. This label will now be described with regard to how it differs from the labels 100 and 200 described previously. The reference numbers will be retained in as far as they designate similar elements.

In this third embodiment, the chip assembly 302 comprises an opaque support 320. The chip and its antenna, invisible to the eye, are represented in dot-and-dash lines in FIG. 5. They are arranged between the support 320 of the chip assembly and the sheet 1 of the tag.

The support is also printable. It can comprise, for example thermal paper. Moreover, current technologies makes it possible to produce electronic components which are very thin, in particular radiofrequency chips. Thus it is possible to use a part of the printable surface 14 of the tag, not covered by the chip assembly, and the support 320 in order to form a single global printable surface for the label.

The printing is then carried out after the placement of the chip assembly on the tag.

Of course, the invention is not limited to the examples which have just been described and numerous adjustments can be made to these examples without exceeding the scope of the invention.

Thus, a tag can be formed using a consumable in a strip. This consumable in a strip can in particular be cut in the form of a tag before or after the printing and/or the placing of the chip assembly.

Moreover, the transparent elements can be replaced by translucent elements, and vice versa, provided that they allow printed information to be read through them.

The invention can be used in order to form types of labels other than luggage labels. In particular, it can be used in order to form labels for any type of object, particularly if the information recorded there was recorded on request, i.e. if it is intended to differentiate the object from identical or similar objects. Thus, the sheet can be transparent or translucent to visible or infrared light or also to ultraviolet light, which can make it possible to read a barcode through the sheet.

The label thus formed is understood to mean any type of identification support comprising a sheet onto which a chip is affixed. It can be a game coupon on which the number and optionally the winnings are recorded on both the sheet and the chip, and optionally comprising the identification of a player carrying it. It can also be a ticket identifying a traveller.

The chip can be placed directly onto the object (or its packaging) that it identifies, and the object (or its packaging) serves as a support for the printing.

The chip can also not be of the radiofrequency type, and not comprise an antenna, and be readable by contact.

1. A method for forming a label comprising a chip affixed to a sheet, the chip being provided on a support where the label is formed by applying said support to a surface of the sheet and by printing first information which individualizes the label, characterized in that said support and said surface thus form a part of the label where the first printed information is readable.

2. The method according to claim 1, characterized in that a radiofrequency chip is affixed, the chip containing second information individualizing the label.

3. The method according to claim 1, characterized in that the first information is printed onto the surface, before applying thereto a transparent or translucent support covering, at least partially, said first information.

4. The method according to claim 3, characterized in that the support is applied in such a way that the chip is offset beyond one edge of the sheet.

5. The method according to claim 1, characterized in that the first information is printed after having applied a printable support to the surface.

6. The device for implementing a method according to claim 1.

7. A label comprising a chip affixed to a sheet, the chip being provided on a support applied to a surface of the sheet, said label comprising first written information individualizing the label, characterized in that said support and said surface form a part of the label where the first information is readable.

8. The label according to claim 7, characterized in that the support is translucent or transparent.

9. The label according to claim 8, characterized in that the chip is offset relative to one edge of the sheet.

10. The label according to claim 8, characterized in that the chip comprises a transparent or translucent antenna.

11. The label according to claim 10, characterized in that the chip and its antenna are arranged between the support and the surface.

12. The label according to claim 8, characterized in that the support at least partially covers the first information.

13. The label according to claim 7, characterized in that the support is printable.

14. The label according to claim 13, characterized in that the first information is printed, at least partially, onto the support.

15. The method according to claim 2, characterized in that the first information is printed onto the surface, before applying thereto a transparent or translucent support covering, at least partially, said first information.

16. The method according to claim 2, characterized in that the first information is printed after having applied a printable support to the surface.

17. The device for implementing a method according to claim 2.

18. The device for implementing a method according to claim 6.

19. The label according to claim 9, characterized in that the support at least partially covers the first information.

20. The label according to claim 10, characterized in that the support at least partially covers the first information.
